(19) United States
(12) Patent Application Publication
(10) Pub. No.: US 2012/0145475 A1
(43) Pub. Date: Jun. 14, 2012

(54) Apparatus and method for generating and propagating polarized acousto-elastic waves

(76) Inventor: James Graham Dunkelberg, Houston, TX (US)

(21) Appl. No.: 12/928,517

(22) Filed: Dec. 13, 2010

(51) Int. Cl. G01V 1/02

(52) U.S. Cl. 181/113

(57) ABSTRACT

The invention is a polarized seismic wave generator used within a cavity for propagating polarized acousto-elastic shockwaves into surrounding cavity strata. The invention comprises segments with orient-able acousto-elastic shockwave sources, the segment also having shockwave mitigation material. Each shockwave source is configured to generate acousto-elastic shockwaves into surrounding cavity strata, whereby the shockwave mitigation material decouples the generated wave fields. Each segment is constructed to fix the relative azimuthal orientation and vertical inclination of the acousto-elastic shockwave sources. The invention also comprises a frame with a major axis oriented in a vertical relationship with respect to the cavity, the frame holding each segment in a fixed position relative to other segments within the cavity. The invention includes a frame loading segment for loading and fixing the frame within the cavity in a desired azimuthal orientation, and an ignition element for controlling the initiation, sequence and timing of detonation of acousto-elastic shockwave sources. Each segment is aligned in The frame by a frame alignment element. The seismic wave generator may include a stabilizing element for stabilizing the frame in the cavity, and may further include a coupling element for coupling the frame to the cavity;

### RELATED APPLICATIONS

This application is related to U.S. patent application Ser. No. 61/217,151 entitled Method for generation of polarized shear and compression waves using shaped charges, filed Jun. 12, 2010, which is included herein by reference.

### FIELD

The present invention relates generally to the field of geophysical exploration and subsurface characterization systems and more particularly to a method, system and device for generating compressional and polarized shear waves encompassing the full seismic wave field. The historical drawbacks and deficiencies of previous methods and sources are well documented and understood by those skilled in the art and are numerous.

### BACKGROUND

For many years, the geophysical industry has attempted to generate compressional (P) and longitudinal (S or shear or horizontal) seismic waves for subsequent capture, processing and interpretation of the reflected seismic signals for each type of seismic wave generated.

Historical land sources for generation of P and S waves using dynamite was pioneered by Russians geophysicists, such as those described by Puzyrev et al. (1966) and Brodev et al. (1968). These sources relied on cancellation of P wave by subtraction of signals of oppositely phased, polarized S waves that were obtained by separate detonation of charges on opposite sides of a cavity previously created by detonation of a P wave charge for the P wave component of the seismic survey. This method was later commercially adapted by Compangnie General de Geophysique (CGG) under the trademark of SYSLAP®. This method is also referred to as “camouflage shooting” whether the shot holes have been drilled vertically into the subsurface or have been created in a horizontal manner. This method is sometimes confused with “trench shooting” and the two methods are often used interchangeably. The main deficiency was the extensive damages to the ground surface thus severely limiting the geographic areas where the source could be used.

Historical land sources for generation of P and S waves using impulse and impact sources include inclined land air guns (“OMNIPULSE”) which generated good P-Sh, but was deficient economically as the truck had to be re-aligned to source P-Sv in orthogonal source line direction. This method is both time consuming and expensive and in many areas land owners would not allow permits for such excessive damages related to the re-alignment and turn-around areas for the trucks.

Other mechanical impact sources such as Marthor® used a swing-arm weight drop or hammer against a baseplate of a truck or vehicle with the base plate being held down by the weight of the truck. This source was deficient as it literally beat itself apart. Atlantic Richfield Company developed a source called ARIES, which used compressed air to drive a piston in the horizontal direction. The piston was coupled to an articulating mass and was held down and loosely coupled to the ground surface using the weight of the truck. Due to low signal to noise ratio, this method did not prove economically or technically viable. Other inclined weight drop and inclined accelerated weight drop impact source such as “VectaPulse” is also deficient in that the source points have to occupied for excessive periods of time and requires multiple impact strikes, in different directions and against the ground. This must be repeated for each desired or required component with each strike being followed by a predetermined listen time of 3 to 6 seconds for each weight drop and repeated for each source point. The VectaPulse, like all impact sources, has a tendency to beat itself apart. Due to the size of the trailer system required to tow the VectaPulse mass into position, surface damages and accessibility are also a concern.

Multicomponent vibrator sources were used starting in 1977, mainly by Conoco. Conoco lead a 22 member shear wave exploration consortium. The multicomponent vibrator sources proved effective, but each source point had to be occupied three (3) times, once for P, once for Sv, and once for Sh source initiation. The costs of occupying the source points three (3) times proved to be uneconomical at the time as did the lack of recording capacity of the recording systems, lack of proper phase lock technology using multiple vibrators, and lack of ground force control to keep multiple vibrators synchronized. Increased sweep effort did little to increase signal to noise ratio as the baseplate of the vibrators was not coupled to the surface of the ground and also had trouble staying in phase when more than one vibrator was being used on the same source using the same shear wave sweep parameters.

Modern vibrators have pretty much solved the issues with the addition of ground force control and phase lock for multiple vibrators occupying the same source point at the same time. However pad generated noise and low frequency still hamper the effectiveness of the shear wave vibrators. There is also emerging research raising further concern as to the energy distribution and directivity of multiple shear vibrator sources. There are also many environmentally sensitive areas where vibrator trucks are not allowed due to size limitations, and excessive damages.

Those skilled in the art understand the historical effort to initiate four (4) distinct S wave sources that are separate and apart from one another and have four (4) distinctly separate polarizations in addition to the separate P wave source initiation.

A modern example of this type of method is described in U.S. Pat. No. 5,907,132 issued to Hardage on May 25, 1999 and incorporated herein by reference. According to Hardage a plurality of shaped or directional charges contained and vertically stacked within an explosive package is placed into a shot hole and is generally “eye ball” oriented relative to a regular spaced, orthogonal source line and receiver line 3D grid. The plurality of shaped or directional charges in the explosive package are detonated simultaneously in order to produce a single horizontal force vector relative to the 3D grid source and receiver line directions. This step must be repeated four (4) separate times in four (4) separate shot holes to generate the required polarized shear components. In addition, a fifth shot hole with a conventional dynamite source is also be used to generate a P wave source. All together, these sources are used to generate the full seismic wave field source. This method is deficient in several ways from the approach of the present invention.

Economically, the present invention is superior to previous teachings in that the present invention requires only one (1) shot hole instead of five (5) shot holes to generate the full seismic wavefield. The present invention is also superior to previous teachings in that the orientation of the sources is independent of the source line and receiver line directions or spacing of the 3D grid and source wave interference mitigation materials designed specifically to enhance signal to noise ratio and provide for more focused and better coupled transmission of polarized shear waves and compressional waves into the surrounding rock strata are not present in prior art or teachings. The present invention also provides for precise orientation of the sources relative to the axis of the geophone receiver axes as well as very precise detonation sequencing, timing and superior signal to noise ratio and broader bandwidth.

When combined together, the source and receiver would represent the sourcing and capturing of the full elastic seismic wave field. This is mainly due to the theory that the summed result of the seismic waves would have a higher signal-to-noise ratio than the individual signals, as the noise present in any particular signal is generally random, while the reflection signal from the reflection point is generally repeatable. Those skilled in the art generally understand the term “reflection point” refers to an “area” at depth of a reflecting interface from which seismic reflection energy is integrated over an area having a diameter of about 1/10^{th} the reflector depth as opposed to a mathematically precise point. When the full seismic wave field is generated and those signals have been subsequently captured, processed and interpreted, determination of subsurface structure, subtle subsurface stratigraphic relationships or rock strata can provide greater resolution and understanding of the subsurface rock strata properties for use in oil, gas and mineral exploration, exploitation and characterization.

### OBJECTS

In view of the prior art and its limitations, it is therefore an object of the present invention to provide the means for propagating acousto-elastic waves having the maximum signal-to-noise ratio possible.

The present invention overcomes the historical and current drawbacks and deficiencies of prior art including: minimal surface damage; fewer shot holes; repeatability and ease of use in field operations and implementation; overall economic costs; maximization of signal to noise ratio; proper coupling; repeatability; reducing or eliminate confusing field nomenclature; accessibility to more geographic areas; broader bandwidth; improved means of initiation, sequencing and detonation of source pulses.

### SUMMARY

The invention is a polarized seismic wave generator that is inserted into a cavity to propagate polarized acousto-elastic shockwaves into surrounding cavity strata. The invention comprises at least two segments having orient-able acousto-elastic shockwave sources and also having shockwave mitigation material. Each shockwave source is configured to propagate acousto-elastic shockwaves of a desired direction and orientation into surrounding cavity strata. Each segment is constructed to maintain a fixed azimuthal orientation and vertical inclination with respect to other segments. The invention includes a frame with a major axis oriented in a vertical relationship with respect to the cavity, the frame holding each segment in a fixed position relative to other segments within the cavity. The invention includes a removable loading segment for loading and fixing the frame within the cavity in a desired azimuthal orientation, and an ignition element for controlling the initiation, sequence and timing of detonation of acousto-elastic shockwave sources. The seismic wave generator is also be equipped with a stabilizing element for stabilizing the frame in the cavity, and may further include a coupling element for coupling the frame to the cavity.

### DESCRIPTION OF THE DRAWINGS

FIG. 1 is a perspective view of a mechanism for use within a cavity for propagation of polarized acousto-elastic shockwaves from the mechanism into surrounding cavity strata. The mechanism is composed of at least two (2) segments that lock together using a segment locking mechanism. Each segment contains an orient-able acousto-elastic shockwave source. The acousto-elastic shockwave source may be constructed in various sizes, compositions, lengths, geometries, and emplaced in the segment. The acousto-elastic shockwave source is surrounded by shockwave mitigation material within the segment. Each segment is constructed to fix the relative azimuthal orientation and vertical inclination of the acousto-elastic shockwave source with regards to the segment azimuthal and inclination reference line. Upon assembly, the segments of the mechanism have a frame alignment element as a reference for orienting the frame within a cavity. Propagation of the acousto-elastic shockwave source is initiated by means of an ignition element controlling the initiation, timing, and sequence of detonation of the acousto-elastic shockwave sources; and

FIG. 1-a is a perspective view of a mechanism for use within a cavity for propagation of polarized acousto-elastic shockwaves from the mechanism into surrounding cavity strata. The mechanism is composed of at least two (2) segments that lock together using a segment locking mechanism. Each segment contains an orient-able acousto-elastic shockwave source. The acousto-elastic shockwave source may be constructed in various sizes, compositions, lengths, geometries, and emplaced in the segment. The acousto-elastic shockwave source is surrounded by shockwave mitigation material within the segment. Each segment is constructed to fix the relative azimuthal orientation and vertical inclination of the acousto-elastic shockwave source with regards to the segment azimuthal and inclination reference line. Upon assembly, the segments of the mechanism have a frame alignment element as a reference for orienting the frame within a cavity. The frame further includes a stabilizing and anchoring element to hold the frame in place within the cavity. Propagation of the acousto-elastic shockwave source is initiated by means of an ignition element controlling the initiation, timing, and sequence of detonation of the acousto-elastic shockwave sources; and

FIG. 1-b is a perspective view of a mechanism for use within a cavity for propagation of polarized acousto-elastic shockwaves from the mechanism into surrounding cavity strata. The mechanism is composed of three (3) segments that lock together using a segment locking mechanism. Two (2) of the three (3) segments contains an orient-able acousto-elastic shockwave source. The third segment contains shockwave mitigation material and is held in place by a segment locking mechanism. The acousto-elastic shockwave source may be constructed in various sizes, compositions, lengths, geometries, and emplaced in the segment. The acousto-elastic shockwave source is surrounded by shockwave mitigation material within the segment. Two (2) of the three (3) segments are constructed to fix the relative azimuthal orientation and vertical inclination of the acousto-elastic shockwave source with regards to the segment azimuthal and inclination reference line. Upon assembly, the segments of the mechanism have a frame alignment element as a reference for orienting the frame within a cavity. The third segment contains shockwave mitigation material and is constructed to fix the relative segment azimuthal and inclination reference line in line with the other segments and is held in place by a segment locking mechanism. The frame further includes a stabilizing and anchoring element to hold the frame in place within the cavity. Propagation of the acousto-elastic shockwave source is initiated by means of an ignition element controlling the initiation, timing, and sequence of detonation of the acousto-elastic shockwave sources; and

FIG. 1-c is a perspective view of a mechanism for use within a cavity for propagation of polarized acousto-elastic shockwaves from the mechanism into surrounding cavity strata. The mechanism is composed of three (3) segments that lock together using a segment locking mechanism. Each segment contains an orient-able acousto-elastic shockwave source. The acousto-elastic shockwave source may be constructed in various sizes, compositions, lengths, geometries, and emplaced in the segment. The acousto-elastic shockwave source is surrounded by shockwave mitigation material within the segment. Each segment is constructed to fix the relative azimuthal orientation and vertical inclination of the acousto-elastic shockwave source with regards to the segment azimuthal and inclination reference line. Upon assembly, the segments of the mechanism have a frame alignment element as a reference for orienting the frame within a cavity. The frame further includes a stabilizing and anchoring element to hold the frame in place within the cavity. Propagation of the acousto-elastic shockwave source is initiated by means of an ignition element controlling the initiation, timing, and sequence of detonation of the acousto-elastic shockwave sources; and

FIG. 2 is a perspective view of a mechanism for use within a cavity for propagation of polarized acousto-elastic shockwaves from the mechanism into surrounding cavity strata. The mechanism is composed of at least two (2) segments that lock together using a segment locking mechanism. Each segment contains an orient-able acousto-elastic shockwave source. The acousto-elastic shockwave source may be constructed in various sizes, compositions, lengths, geometries, and emplaced in the segment. The acousto-elastic shockwave source is surrounded by shockwave mitigation material within the segment. Each segment is constructed to fix the relative azimuthal orientation and vertical inclination of the acousto-elastic shockwave source with regards to the segment azimuthal and inclination reference line. Upon assembly, the segments of the mechanism have a frame alignment element as a reference for orienting the frame within a cavity. The frame further includes a stabilizing and anchoring element to hold the frame in place within the cavity. The mechanism further includes a frame loader composed of a frame orientation element and loader alignment and reference element, having a major axis oriented in a vertical relationship with respect to the frame and cavity for loading and fixing the frame within the cavity in a desired azimuthal orientation. Propagation of the acousto-elastic shockwave source is initiated by means of an ignition element controlling the initiation, timing, and sequence of detonation of the acousto-elastic shockwave sources; and

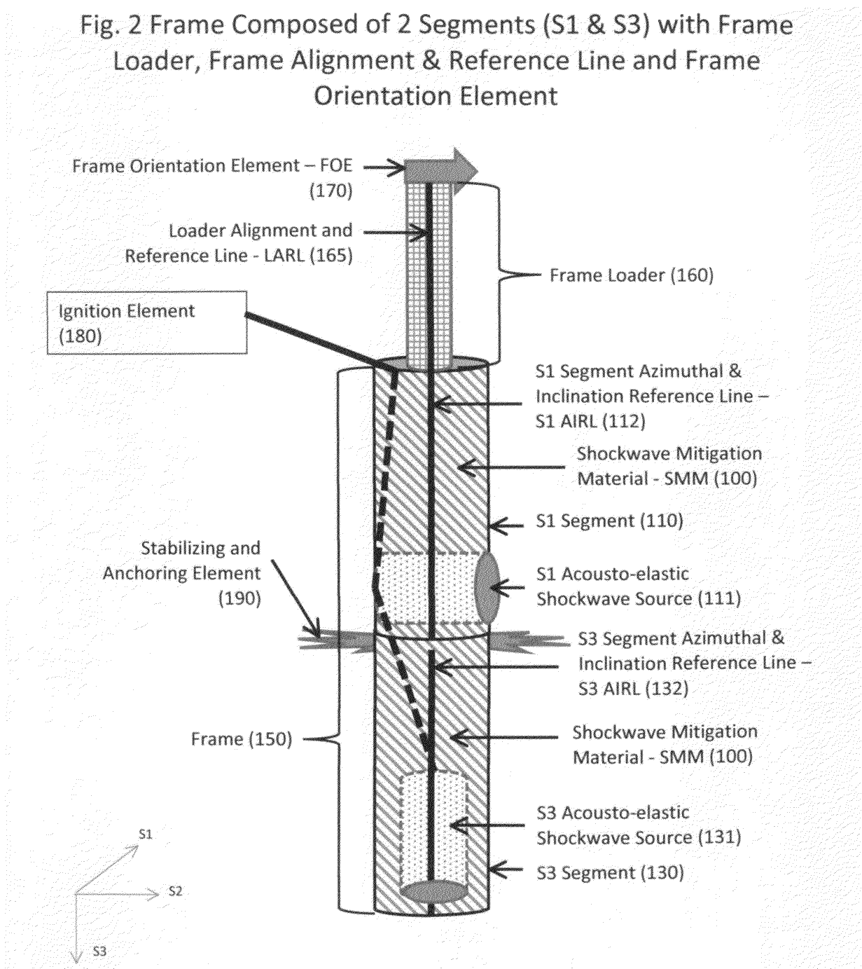

FIG. 2-a is a perspective view of a mechanism for use within a cavity for propagation of polarized acousto-elastic shockwaves from the mechanism into surrounding cavity strata. The mechanism is composed of at least two (2) segments that lock together using a segment locking mechanism. Each segment contains an orient-able acousto-elastic shockwave source. The acousto-elastic shockwave source may be constructed in various sizes, compositions, lengths, geometries, and emplaced in the segment. The acousto-elastic shockwave source is surrounded by shockwave mitigation material within the segment. Each segment is constructed to fix the relative azimuthal orientation and vertical inclination of the acousto-elastic shockwave source with regards to the segment azimuthal and inclination reference line. Upon assembly, the segments of the mechanism have a frame alignment element as a reference for orienting the frame within a cavity. The frame further includes a stabilizing and anchoring element to hold the frame in place within the cavity. The mechanism further includes a frame loader composed of a frame orientation element and loader alignment and reference element, having a major axis oriented in a vertical relationship with respect to the frame and cavity for loading and fixing the frame within the cavity in a desired azimuthal orientation. Propagation of the acousto-elastic shockwave source is initiated by means of an ignition element controlling the initiation, timing, and sequence of detonation of the acousto-elastic shockwave sources; and

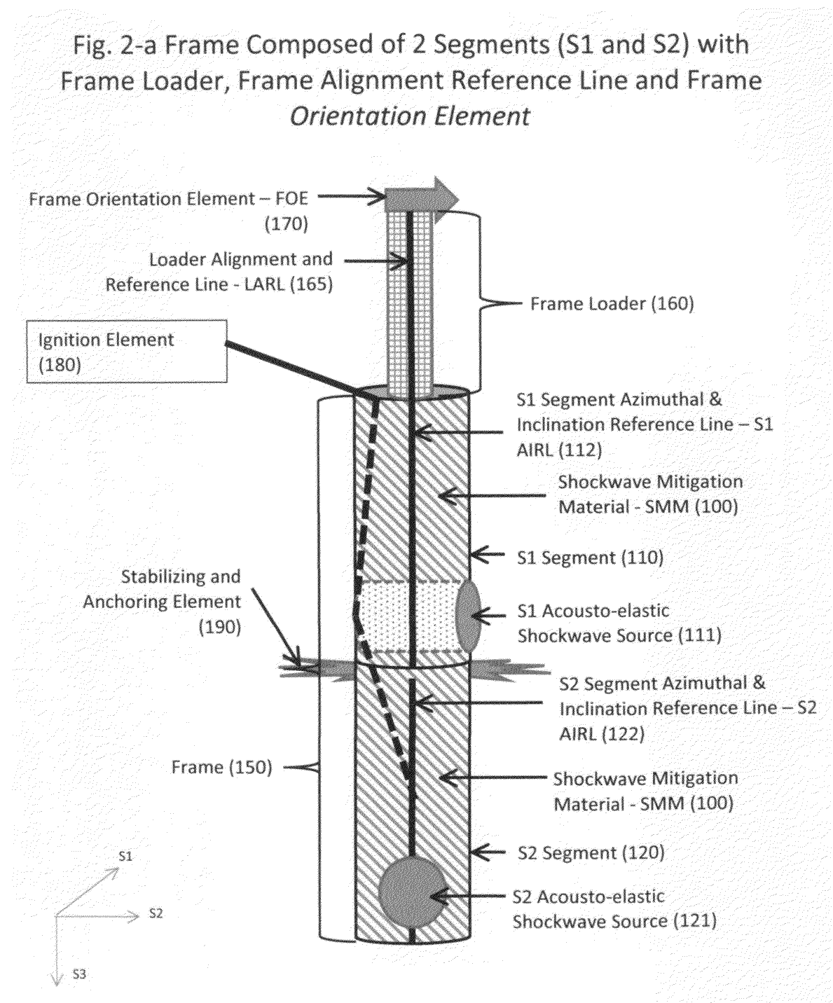

FIG. 3 is a perspective view of a mechanism for use within a cavity for propagation of polarized acousto-elastic shockwaves from the mechanism into surrounding cavity strata. The mechanism is composed of three (3) segments that lock together using a segment locking mechanism. Each segment contains an orient-able acousto-elastic shockwave source. The acousto-elastic shockwave source may be constructed in various sizes, compositions, lengths, geometries, and emplaced in the segment. The acousto-elastic shockwave source is surrounded by shockwave mitigation material within the segment. Each segment is constructed to fix the relative azimuthal orientation and vertical inclination of the acousto-elastic shockwave source with regards to the segment azimuthal and inclination reference line. Upon assembly, the segments of the mechanism have a frame alignment element as a reference for orienting the frame within a cavity. The frame further includes a stabilizing and anchoring element to hold the frame in place within the cavity. The mechanism further includes a frame loader composed of a frame orientation element and loader alignment and reference element, having a major axis oriented in a vertical relationship with respect to the frame and cavity for loading and fixing the frame within the cavity in a desired azimuthal orientation. Propagation of the acousto-elastic shockwave source is initiated by means of an ignition element controlling the initiation, timing, and sequence of detonation of the acousto-elastic shockwave sources; and

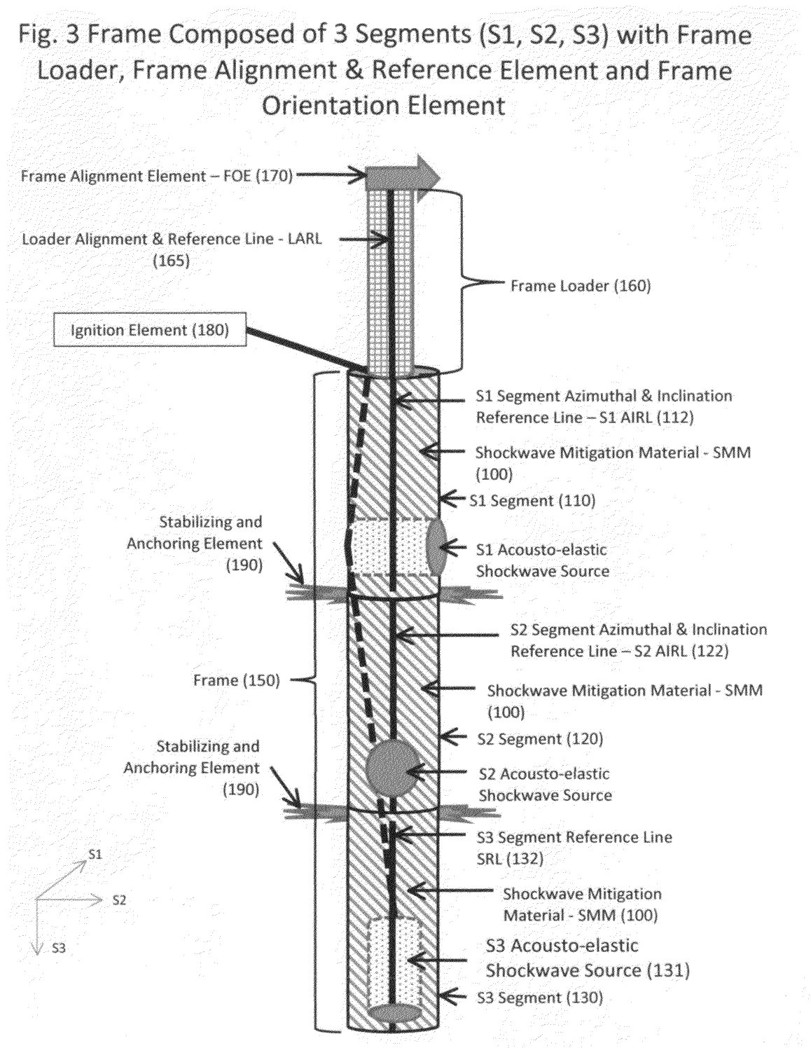

FIG. 4 is a view of a cavity where the cavity has a long axis, a cavity wall, and surrounding cavity strata. The cavity can be of a plurality of diameters and depths as desired or required; and

FIG. 4-a is a view of a cavity where the cavity has a long axis, a cavity wall, and surrounding cavity strata. The cavity can be of a plurality of diameters and depths as desired or required. Within the cavity is a perspective view of a mechanism for use within a cavity for propagation of polarized acousto-elastic shockwaves from the mechanism into surrounding cavity strata. The mechanism is composed of four (4) segments that lock together using a segment locking mechanism. Three (3) of the four (4) segments contains an orient-able acousto-elastic shockwave source. The acousto-elastic shockwave source may be constructed in various sizes, compositions, lengths, geometries, and emplaced in the segment. The acousto-elastic shockwave source is surrounded by shockwave mitigation material within the segment. Each segment is constructed to fix the relative azimuthal orientation and vertical inclination of the acousto-elastic shockwave source with regards to the segment azimuthal and inclination reference line. The fourth segment contains shockwave mitigation material and is constructed to fix the relative segment azimuthal and inclination reference line in line with the other segments and is held in place by a segment locking mechanism. Upon assembly, the segments of the mechanism have a frame alignment element as a reference for orienting the frame within a cavity. The frame further includes a stabilizing and anchoring element to hold the frame in place within the cavity. Propagation of the acousto-elastic shockwave source is initiated by means of an ignition element controlling the initiation, timing, and sequence of detonation of the acousto-elastic shockwave sources; and

FIG. 4-b is a view of a cavity where the cavity has a long axis, a cavity wall, and surrounding cavity strata. The cavity can be of a plurality of diameters and depths as desired or required. Within the cavity is a perspective view of a mechanism for use within a cavity for propagation of polarized acousto-elastic shockwaves from the mechanism into surrounding cavity strata. The mechanism is composed of four (4) segments that lock together using a segment locking mechanism. Three (3) of the four (4) segments contains an orient-able acousto-elastic shockwave source. The acousto-elastic shockwave source may be constructed in various sizes, compositions, lengths, geometries, and emplaced in the segment. The acousto-elastic shockwave source is surrounded by shockwave mitigation material within the segment. Each segment is constructed to fix the relative azimuthal orientation and vertical inclination of the acousto-elastic shockwave source with regards to the segment azimuthal and inclination reference line. The fourth segment contains shockwave mitigation material and is constructed to fix the relative segment azimuthal and inclination reference line in line with the other segments and is held in place by a segment locking mechanism. Upon assembly, the segments of the mechanism have a frame alignment element as a. reference for orienting the frame within a cavity. The frame further includes a stabilizing and anchoring element to hold the frame in place within the cavity. The mechanism further includes a frame loader composed of a frame orientation element and loader alignment and reference element, having a major axis oriented in a vertical relationship with respect to the frame and cavity for loading and fixing the frame within the cavity in a desired azimuthal orientation. Propagation of the acousto-elastic shockwave source is initiated by means of an ignition element controlling the initiation, timing, and sequence of detonation of the acousto-elastic shockwave sources; and

FIG. 4-c is a view of a cavity where the cavity has a long axis, a cavity wall, and surrounding cavity strata. The cavity can be of a plurality of diameters and depths as desired or required. Within the cavity is a perspective view of a mechanism for use within a cavity for propagation of polarized acousto-elastic shockwaves from the mechanism into surrounding cavity strata. The mechanism is composed of four (4) segments that lock together using a segment locking mechanism. Three (3) of the four (4) segments contains an orient-able acousto-elastic shockwave source. The acousto-elastic shockwave source may be constructed in various sizes, compositions, lengths, geometries, and emplaced in the segment. The acousto-elastic shockwave source is surrounded by shockwave mitigation material within the segment. Each segment is constructed to fix the relative azimuthal orientation and vertical inclination of the acousto-elastic shockwave source with regards to the segment azimuthal and inclination reference line. The fourth segment contains shockwave mitigation material and is constructed to fix the relative segment azimuthal and inclination reference line in line with the other segments and is held in place by a segment locking mechanism. Upon assembly, the segments of the mechanism have a frame alignment element as a reference for orienting the frame within a cavity. The frame further includes a stabilizing and anchoring element to hold the frame in place within the cavity. The mechanism further includes a frame loader composed of a frame orientation element and loader alignment and reference element, having a major axis oriented in a vertical relationship with respect to the frame and cavity for loading and fixing the frame within the cavity in a desired azimuthal orientation. The mechanism further includes a coupling element for coupling the frame to the cavity. Propagation of the acousto-elastic shockwave source is initiated by means of an ignition element controlling the initiation, timing, and sequence of detonation of the acousto-elastic shockwave sources.

### DETAILED DESCRIPTION

### An Exemplary Embodiment Illustrating the Invention

In practice, the present invention overcomes the deficiencies, limitations and drawbacks of previous art by improving the efficiency, operations and implementation of full vector wave field source generation by effectively propagating polarized acousto-elastic shockwaves from the mechanism into surrounding cavity strata. Many elements working in concert are necessary to implement the present invention into commercial practice. This accomplished by focusing on the key aspects of acouto-elastic impulse source propagation from an economic, operations, manufacturing, assembly, implementation, loading and best practices developed over the last twenty six (26) years of applied and applied theoretical studies; namely:
a) Maximize signal to noise ratio
b) Broader bandwidth wave source impulses
c) Better coupling and dampening and coupling wave source impulse charges
d) Better coupling and dampening of the frame and charges to the cavity or shot hole
e) Reduced number of shot holes necessary
f) Ensure proper hole loading, alignment to required direction, and hold down of frame
g) Improved means of wave source pulse initiation and duration
h) Increased accessibility to more geographic areas currently restricted from use with prior art, such as Vibroseis, VectaPulse, or other multi-shot hole dynamite source methods.

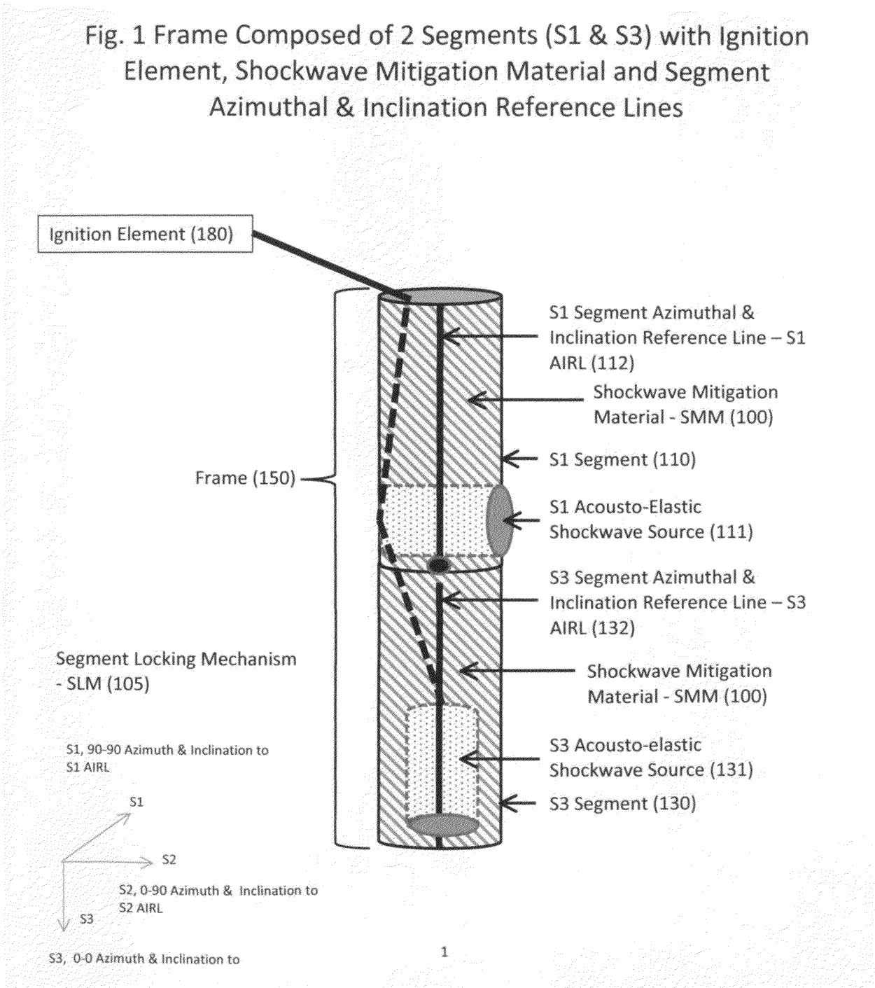

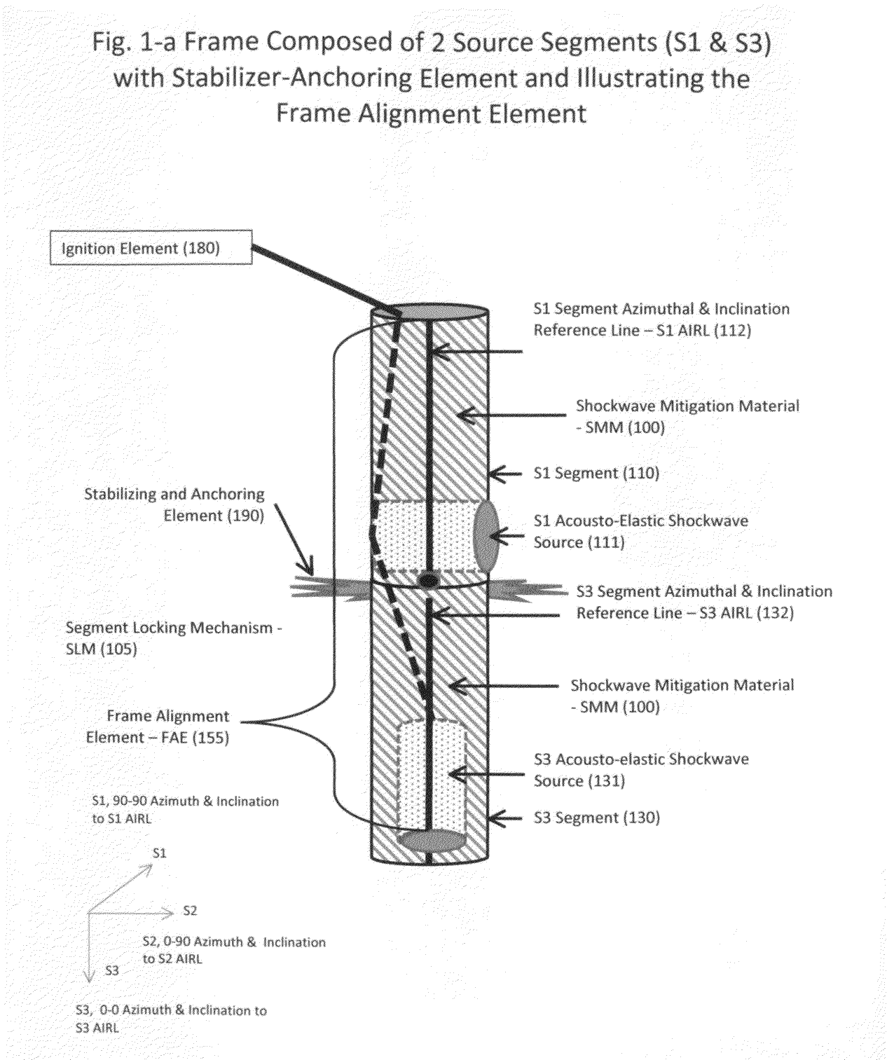

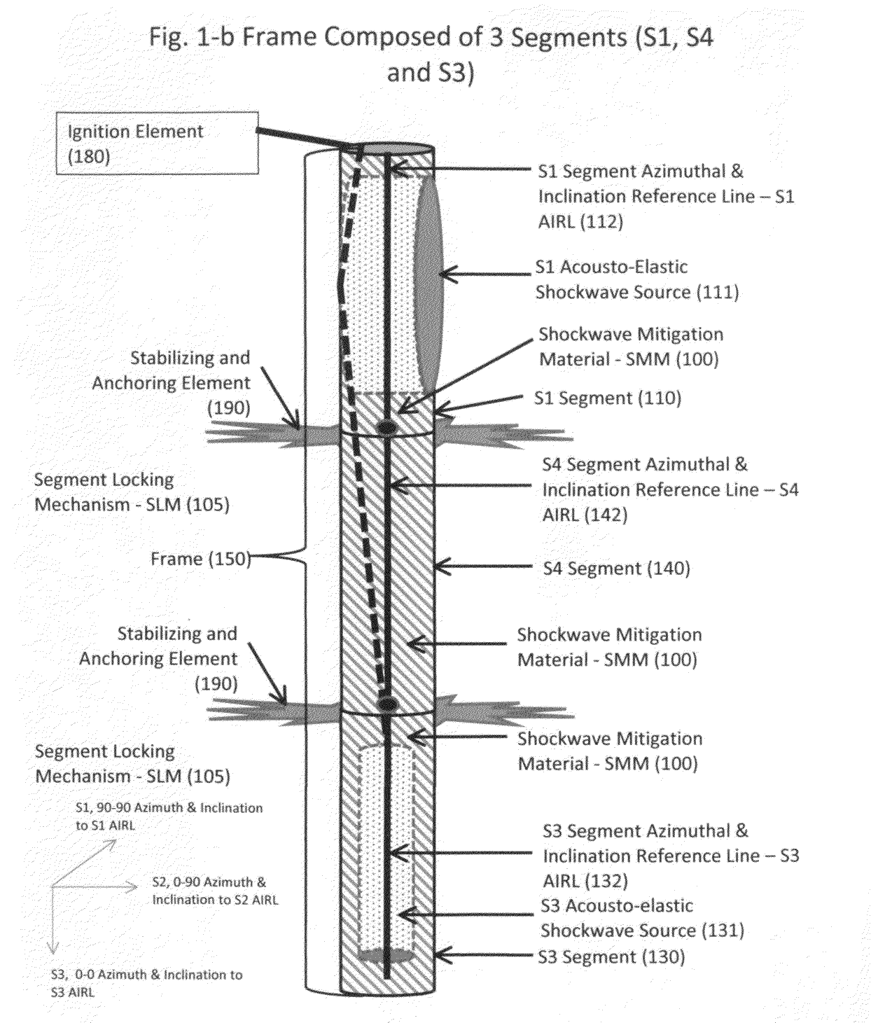

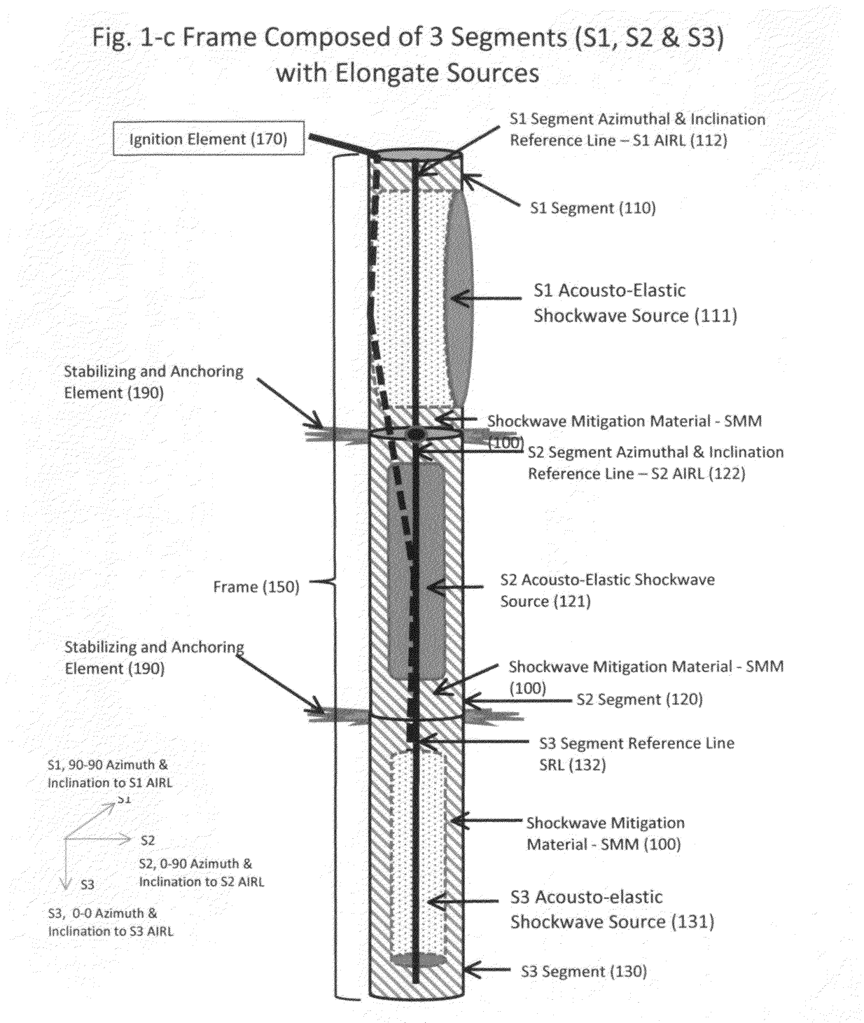

Referring now to the invention in more detail, FIGS. 1, 1-a, 1-b, 1-c, 2, 2-a, 3, 4, 4-a, 4-b, 4-c, shows a perspective view of a mechanism for use within a cavity (200) for propagation of polarized acousto-elastic shockwaves from the mechanism into surrounding cavity strata (215). The mechanism is composed of at least two (2) acousto-elastic shockwave source segments (110, 120, 130) that lock together using a segment locking mechanism (105). Each segment contains orient-able acousto-elastic shockwave source (111, 121, 131). The acousto-elastic shockwave source (111, 121 and 131) may be constructed in various sizes, compositions, lengths, geometries, and emplaced in the segment. The acousto-elastic shockwave source (111, 121, 131) is surrounded by shockwave mitigation material (100) within the segment (110, 120, 130). Each segment (110, 120, 130) is constructed to fix the relative azimuthal orientation and vertical inclination of the acousto-elastic shockwave source (111, 121, 131) with regards to the segment azimuthal and inclination reference line (112, 122, 132, 142). Upon assembly, the segments (110, 120, 130, 140) of the mechanism have a frame alignment element (155) as a reference for orienting the frame (150) within a cavity (200). Propagation of the acousto-elastic shockwave source (111, 121, 131) is initiated by means of an ignition element (180) controlling the initiation, timing, and sequence of detonation of the acousto-elastic shockwave sources (111, 121, 131).

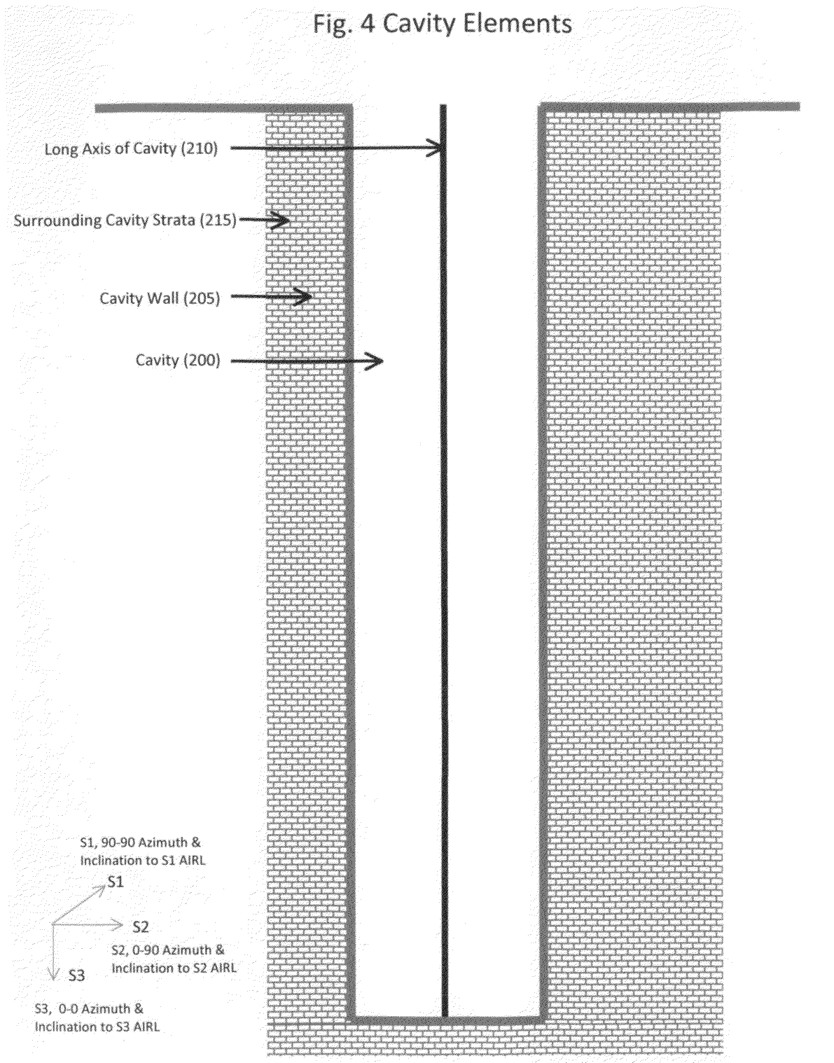

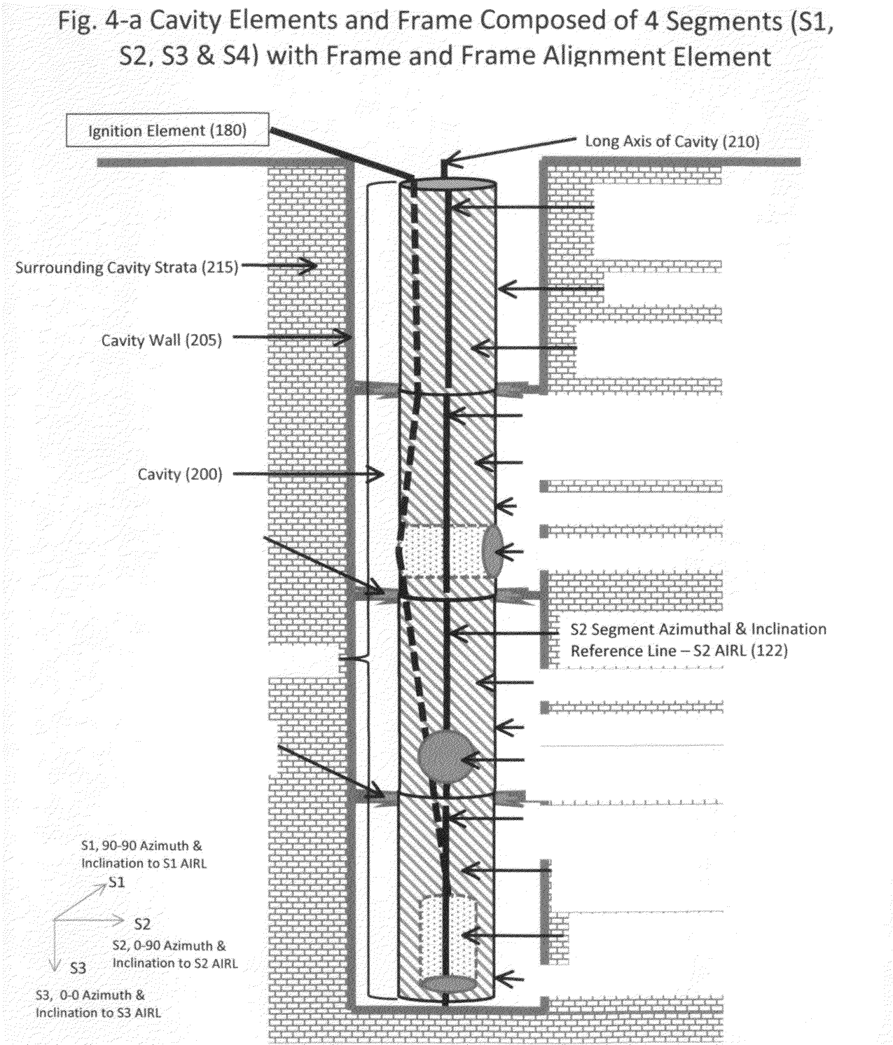

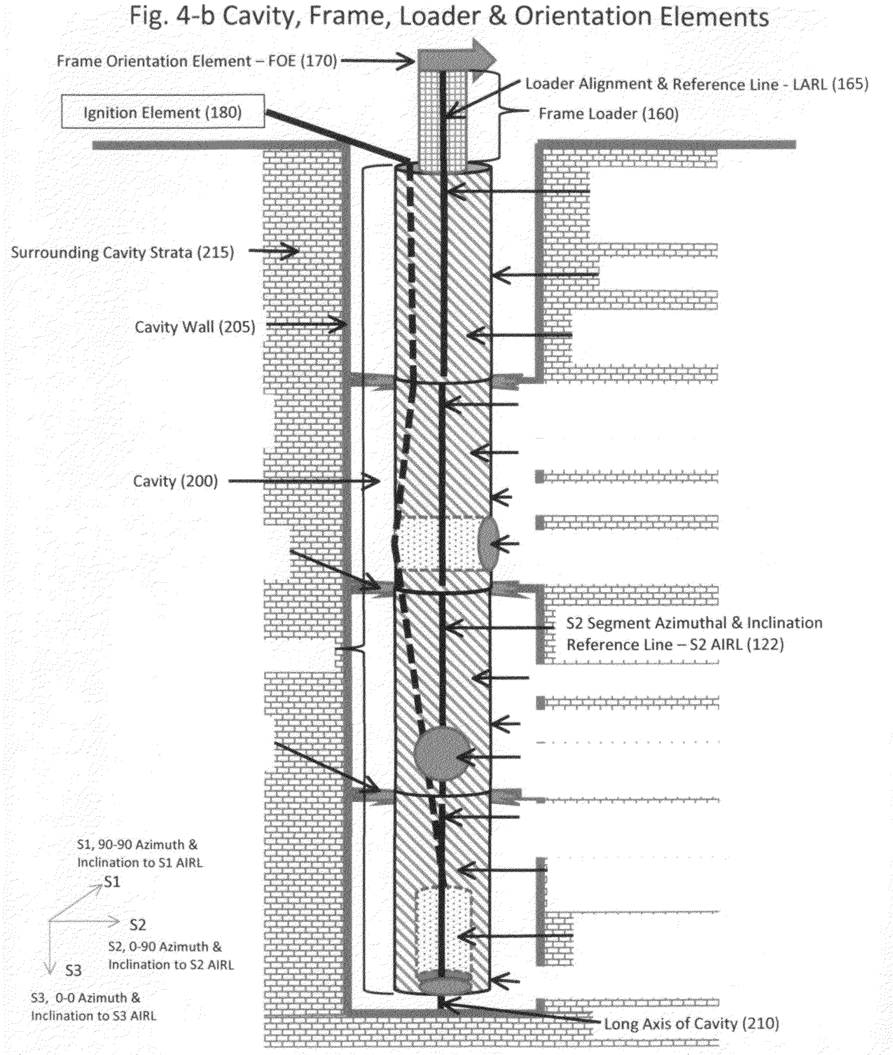

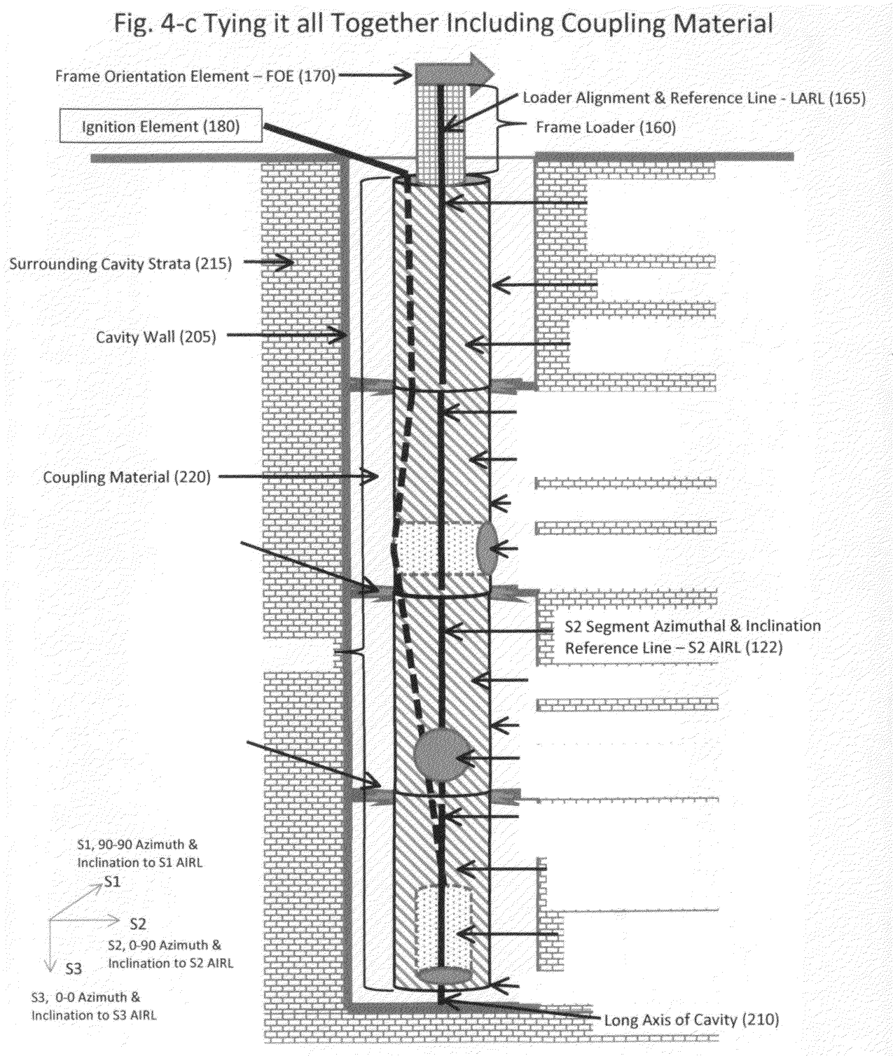

In practice and referring to FIG. 4-c is a view of a cavity (200) where the cavity (200) has a long axis (210), a cavity wall (205), and surrounding cavity strata (215). The cavity (200) can be of a plurality of diameters and depths as desired or required. Within the cavity (200) is a perspective view of a mechanism for use within a cavity (200) for propagation of polarized acousto-elastic shockwaves from the mechanism through the cavity wall (205) into surrounding cavity strata (215). The mechanism is composed of at least four (4) segments (110, 120, 130, 140). The segments (110, 120, 130, 140) lock together using a segment locking mechanism (105). Three (3) of the four (4) segments (110, 120, 130) contain an orient-able acousto-elastic shockwave source (111, 121, 131). The acousto-elastic shockwave source (111, 121, 131) may be constructed in various sizes, compositions, lengths, geometries, and emplaced in the segment (110, 120, 130). The acousto-elastic shockwave source (111, 121, 131) is surrounded by shockwave mitigation material (100) and is in filled within the segment (110, 120, 130). Each segment (110, 120, 130) is constructed to fix the relative azimuthal orientation and vertical inclination of the acousto-elastic shockwave source (111, 121, 131) with regards to the segment (110, 120, 130) azimuthal and inclination reference line (112, 122, 132). The fourth segment (140) contains shockwave mitigation material (100) and is constructed to fix the relative segment azimuthal and inclination reference line (142) in line with the other segments (110, 120, 130, 140) relative segment azimuthal and inclination reference lines (112, 122, 132, 142) and is held in place by a segment locking mechanism (105). Upon assembly, the segments (110, 120, 130, 140) of the mechanism form a frame (150) having a frame alignment element (155) as a reference for orienting the frame (150) within a cavity (200) to the desired or required azimuthal orientation. The frame (150) further includes a stabilizing and anchoring element (190) to hold the frame (150) in place within the cavity (200). The mechanism further includes a frame-loader (160) composed of a frame orientation element (170) and loader alignment and reference line (165), having a major axis oriented in a vertical relationship with respect to the frame (150) and cavity (200) for loading and fixing the frame (150) within the cavity (200) in a desired azimuthal orientation, using the frame orientation element (170). The cavity (200) is filled with coupling material (220) to couple the frame (150) to the cavity wall (205). Propagation of the acousto-elastic shockwave source (111, 121, 131) is initiated by means of an ignition element (180) controlling the initiation, timing, and sequence of detonation of the acousto-elastic shockwave sources (111, 121, 131).

What is claimed is:

1. A mechanism used within a cavity for propagating polarized acousto-elastic shockwaves from the mechanism into surrounding cavity strata, the mechanism comprising:
at least two segments having orient-able acousto-elastic shockwave sources with shockwave mitigation material, each shockwave source configured to generate acousto-elastic shockwaves into surrounding cavity strata, each segment constructed to fix the relative azimuthal-orientation and vertical inclination of the acousto-elastic shockwave sources;
a frame having a major axis oriented in a vertical relationship with respect to the cavity, the frame holding each segment in a fixed position relative to other segments within the cavity;
a frame loader for loading and fixing the frame within the cavity in a desired azimuthal orientation, and;
an ignition element for controlling the initiation, sequence and timing of detonation of acousto-elastic shockwave sources.

2. The mechanism of claim 1, wherein the frame has a frame alignment element for aligning the assembled segments in the frame.

3. The mechanism of claim 1, further including a stabilizing element for stabilizing the frame in the cavity.

4. The mechanism of claim 1, further including a coupling element for coupling the frame to the cavity.
